(19) United States
(12) Patent Application Publication
(10) Pub. No.: US 2015/0378454 A1
(43) Pub. Date: Dec. 31, 2015

(54) MOUSE DEVICE WITH PROMPTING FUNCTION

(71) Applicant: Primax Electronics Ltd., Taipei (TW)

(72) Inventor: JIAN-BIN WU, Taipei (TW)

(21) Appl. No.: 14/515,037

(22) Filed: Oct. 15, 2014

(30) Foreign Application Priority Data
Jun. 30, 2014 (CN) 201410310739.2

(51) Int. Cl. G06F 3/0354

(52) U.S. Cl. CPC G06F 3/03543

(57) ABSTRACT

A mouse device with a prompting function includes a main body, a controlling unit, and a connecting cable. The connecting cable includes a connector, a wire part, an illumination control line, an illumination module, and an operation control line. The illumination control line is connected with the illumination module and the controlling unit. A first illumination control signal or a second illumination control signal is transmitted to the illumination module through the illumination control line. Consequently, a first state light beam or a second state light beam is emitted by the illumination module. Since the wire part is made of a light-transmissible material, the first state light beam or the second state light beam is visible through the wire part. According to the first state light beam or the second state light beam, the user may realize the operation mode of the mouse device.

### FIELD OF THE INVENTION

The present invention relates to a mouse device, and more particularly to a mouse device with a prompting function.

### BACKGROUND OF THE INVENTION

The widely-used input device of a computer includes for example a mouse device, a keyboard device, a trackball device, a touchpad device, or the like. Among these input devices, the mouse device is the most prevailing because it is very easy-to-use for most users. When a mouse device is held by the palm of a user, the user may move the mouse device to control movement of a cursor shown on a display screen of a computer.

Hereinafter, the structures and the functions of a conventional mouse device will be illustrated with reference to FIG. 1. FIG. 1 schematically illustrates the connection between a conventional mouse device and a computer system. The computer system 2 comprises a computer host 21 and a display screen 22. The computer host 21 is in communication with a mouse device 1 and the display screen 22. The computer host 21 has a connecting port 211. A graphic-based window 221 and a cursor 222 are shown on the display screen 22. The mouse device 1 is used for controlling the cursor 222 to have the computer host 21 execute a corresponding command. The mouse device 1 comprises a main body 10, a left button 11, a right button 12, a scroll wheel 13, and a connecting cable 14. The left button 11 is disposed on the main body 10 and located at a left side of the scroll wheel 13. In addition, the left button 11 is exposed outside the main body 10. By pressing down the left button 11, a left button signal is generated. Like the left button 11, the right button 12 is disposed on the main body 10 and located at a right side of the scroll wheel 13. By pressing down the right button 12, a right button signal is generated. The scroll wheel 13 is disposed within the main body 10 and partially exposed outside the main body 10. By rotating the scroll wheel 13, a corresponding scrolling signal is generated. The connecting cable 14 is connected with the main body 10 and protruded outside the main body 10. Through the connecting cable 14, the communication between the mouse device 1 and the computer system 2 is established.

FIG. 2 is a schematic perspective view illustrating the outer appearance of the conventional mouse device of FIG. 1. Please refer to FIGS. 1 and 2. The connecting cable 14 comprises a wire part 141 and a connector 142. A first end of the wire part 141 is connected with the main body 10. A second end of the wire part 141 is connected with the connector 142. An operation control line (not shown) is disposed within the wire part 141. Consequently, the left button signal, the right button signal and the scrolling signal are transmitted to the computer host 21 through the operating control line. Moreover, after the connector 142 is plugged into the connecting port 211 of the computer host 21, the wire part 141 is connected with the computer host 21. For example, the connector 18 is a universal series bus (USB) interface. From the above discussions, during operations of the mouse device 1, various signals are generated and transmitted to the computer host 21 through the connecting cable 14. According to these signals, the computer host 21 performs corresponding actions.

With increasing development of mouse devices, the functions of the mouse devices are gradually increased. For example, a 2D wheel that can be forwardly and backwardly is developed toward a 3D wheel that can be swung leftwards and rightwards. Moreover, in some kinds of mouse devices, the moving resolution may be adjusted according to the practical requirements. The moving resolution of a mouse device denotes the sensitivity of moving the cursor of the computer host when the mouse device is moved for a certain distance. As the moving resolution is increased, the sensitivity of moving the cursor is increased. Moreover, as shown in FIG. 2, the conventional mouse device 1 further comprises a switching element 15. The switching element 15 is disposed on the main body 10 and exposed outside the main body 10. By pressing down the switching element 15, the operation mode of the conventional mouse device 1 is changed. For example, the operation mode associated with the moving resolution is changed.

When the switching element 15 is pressed down once, the moving resolution of the conventional mouse device 1 is changed. For example, the moving resolution is changed from 800 dots per inch (dpi) to 1600 dpi. When the switching element 15 is pressed down again, the moving resolution is changed from 1600 dpi to 800 dpi. In other words, the operation mode of the conventional mouse device 1 is changeable.

However, the conventional mouse device 1 still has some drawbacks. For example, when the conventional mouse device 1 is operated by the user, if the user leaves the computer system 2 for a certain time period and then comes back to operate the computer system 2, the user fails to realize that the conventional mouse device 1 is in the 800-dpi operation mode or the 1600-dpi operation mode. Under this circumstance, the user has to press down the switching element 15 again and then operate the mouse device 1 in order to feel what the operation mode is. In other words, the conventional mouse device 1 is not user-friendly.

Therefore, there is a need of providing a mouse device with a prompting function.

### SUMMARY OF THE INVENTION

An object of the present invention provides a mouse device with a prompting function.

In accordance with an aspect of the present invention, there is provided a mouse device with a prompting function. The mouse device includes a main body, a controlling unit, and a connecting cable. The controlling unit is disposed within the main body. The controlling unit issues a first illumination control signal according to a first switching signal, or the controlling unit issues a second illumination control signal according to a second switching signal. The connecting cable is connected with the controlling unit. The connecting cable is connectable with a computer system. The connecting cable includes a connector, a wire part, an illumination control line, and an illumination module. The connector is plugged into the computer system. The wire part is connected with the connector and the controlling unit. The illumination control line is disposed within the wire part and connected with the controlling unit. The first illumination control signal or the second illumination control signal is transmitted through the illumination control line. The illumination module is disposed within the connector and the wire part, and connected with the illumination control line. The illumination module emits a first state light beam according to the first illumination control signal, or the illumination module emits a second state light beam according to the second illumination control signal. The wire part is made of a light-transmissible material, so that the first state light beam or the second state light beam is visible through the wire part.

In accordance with another aspect of the present invention, there is provided a mouse device with a prompting function. The mouse device includes a main body, a switching element, a controlling unit, and a connecting cable. The switching element is disposed on the main body and exposed outside the main body. By adjusting the switching element, a first switching signal or a second switching signal is selectively generated. The controlling unit is disposed within the main body and connected with the switching element. An operation mode of the mouse device is adjusted by the controlling unit according to the first switching signal or the second switching signal. The connecting cable is connected with the controlling unit and the switching element. The connecting cable is connectable with a computer system. The connecting cable includes a connector, a wire part, an illumination control line, and an illumination module. The connector is plugged into the computer system. The wire part is connected with the connector and the controlling unit. The illumination control line is disposed within the wire part and connected between the switching element and the controlling unit. The first switching signal or the second switching signal is transmitted through the illumination control line. The illumination module is disposed within the connector and the wire part, and connected with the illumination control line. The illumination module emits a first state light beam according to the first switching signal, or the illumination module emits a second state light beam according to the second switching signal. The wire part is made of a light-transmissible material, so that the first state light beam or the second state light beam is visible through the wire part.

That is, the illumination control line is additionally disposed within the wire part. The illumination control line is connected with the illumination module and the controlling unit, or connected between the controlling unit and the switching element. Different illumination control signals (or switching signals) may be transmitted through the illumination control line. Consequently, different state light beams may be generated by the illumination module. Moreover, since the wire part of the connecting cable is made of a light-transmissible material, a first state light beam or a second state light beam may be viewed by the user through the wire part. According to the first state light beam or the second state light beam, the user may realize the operation mode of the mouse device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse device and a computer system;

FIG. 2 is a schematic perspective view illustrating the outer appearance of the conventional mouse device of FIG. 1;

FIG. 3 schematically illustrates the connection between a computer system and a mouse device according to a first embodiment of the present invention, in which the mouse device has a prompting function;

FIG. 4 is a schematic perspective view illustrating the structure of the mouse device according to the first embodiment of the present invention;

FIG. 5 is a schematic cross-sectional view illustrating the inner structure of the mouse device according to the first embodiment of the present invention;

FIG. 6 is a schematic functional block diagram illustrating the mouse device according to the first embodiment of the present invention;

FIG. 7 is a schematic perspective view illustrating the structure of a mouse device with a prompting function according to a second embodiment of the present invention;

FIG. 8 is a schematic functional block diagram illustrating the mouse device according to the second embodiment of the present invention;

FIG. 9 schematically illustrates the position of the switching element of the mouse device in a first operation mode according to the second embodiment of the present invention; and

FIG. 10 schematically illustrates the position of the switching element of the mouse device in a second operation mode according to the second embodiment of the present invention.

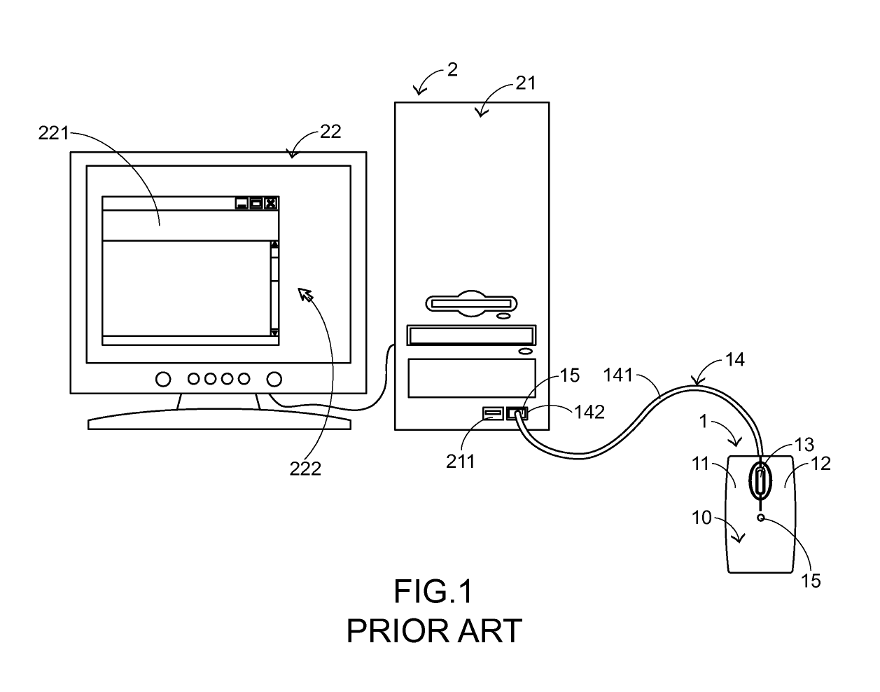

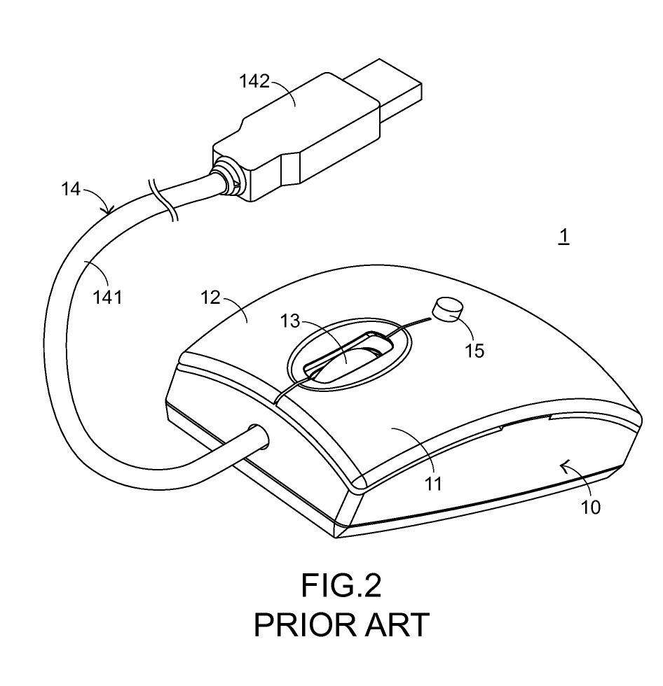

### DETAILED DESCRIPTION OF THE PREFERRED EMBODIMENT

For overcoming the drawbacks of the conventional mouse device, the present invention provides a mouse device with a prompting function.

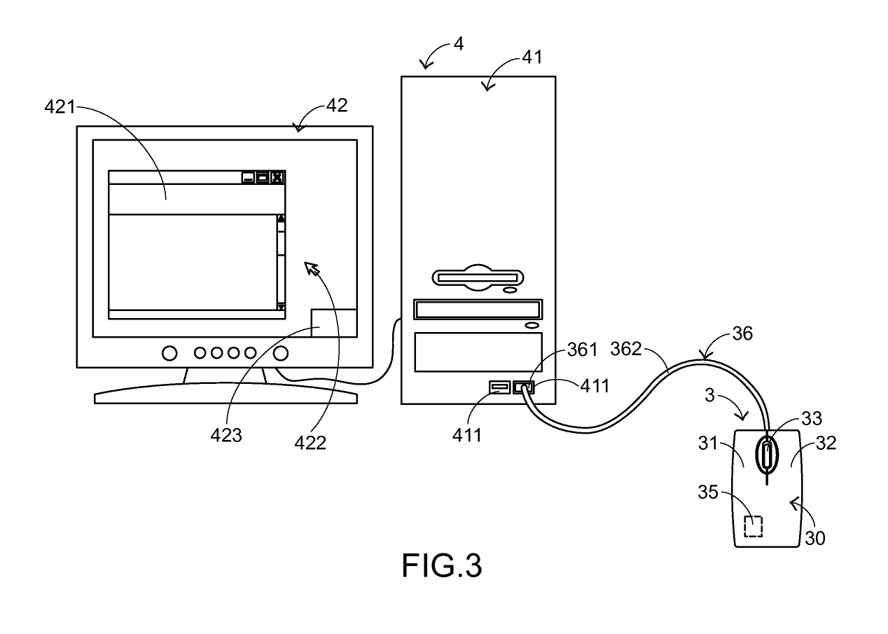

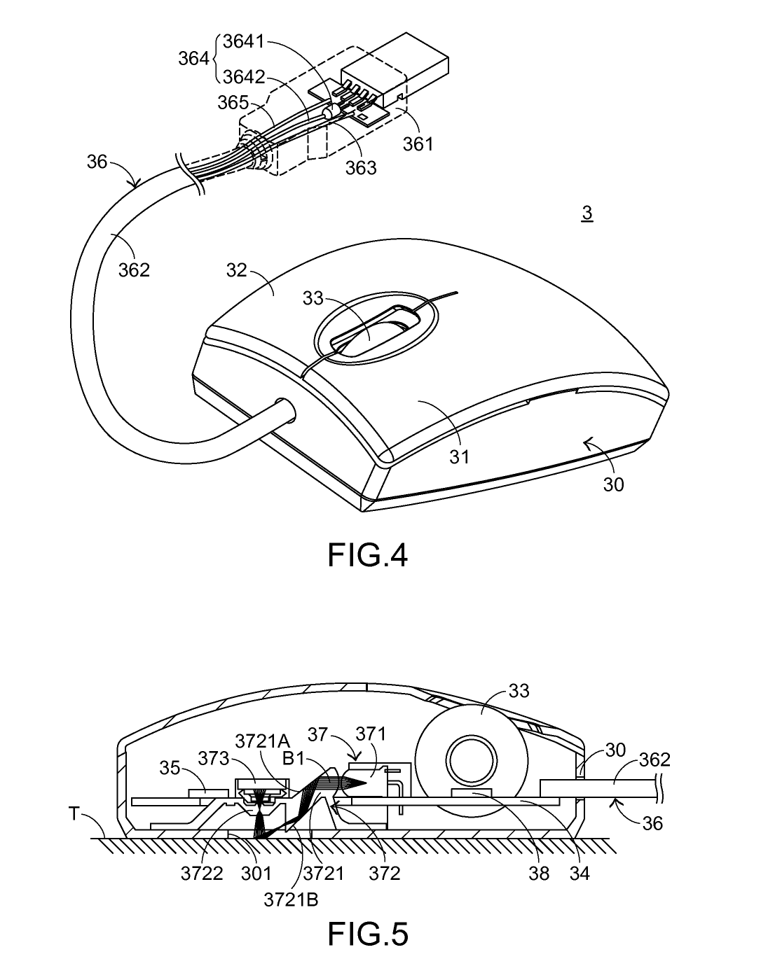

Hereinafter, the structure of a mouse device with a prompting function will be illustrated with reference to FIGS. 3 and 4. FIG. 3 schematically illustrates the connection between a computer system and a mouse device according to a first embodiment of the present invention, in which the mouse device has a prompting function. FIG. 4 is a schematic perspective view illustrating the structure of the mouse device according to the first embodiment of the present invention. The mouse device 3 is in communication with a computer system 4. The computer system 4 comprises a computer host 41 and a display screen 42. The computer host 41 is in communication with a mouse device 3 and the display screen 42. The computer host 41 has a connecting port 411. A graphic-based window 421 and a cursor 422 are shown on the display screen 42. The mouse device 3 is used for controlling the cursor 422 to have the computer host 41 execute a corresponding command. The mouse device 3 comprises a main body 30, a first button 31, a second button 32, a scrolling element 33, a circuit board 34, a controlling unit 35, a connecting cable 36, a displacement detecting module 37 (see FIG. 5), a first triggering switch (not shown), and a second triggering switch 38 (see FIG. 5).

FIG. 5 is a schematic cross-sectional view illustrating the inner structure of the mouse device according to the first embodiment of the present invention. Please refer to FIGS. 3, 4 and 5. The mouse device 3 is placed on a working surface T. In the mouse device 3, the scrolling element 33 is disposed within the main body 30 and partially exposed outside the main body 30. By rotating the scrolling element 33, the scrolling element 33 is enabled to generate a scrolling signal. The first button 31 is disposed on the main body 30, exposed outside the main body 30, and located at a first side of the scrolling element 33. When the first button 31 is pressed down by the user, the first triggering switch under the first button 31 is triggered. Like the first button 31, the second button 32 is disposed on the main body 30, exposed outside the main body 30, and located at a second side of the scrolling element 33. When the second button 32 is pressed down by the user, the second triggering switch 38 under the second button 32 is triggered. The circuit board 34 is disposed within the main body 30. The first triggering switch and the second triggering switch 38 are both disposed on the circuit board 34, and aligned with the first button 31 and the second button 32, respectively. When the first triggering switch is pressed by the first button 31 or the second triggering switch 38 is pressed by the second button 31, a corresponding button signal is generated. In this embodiment, the scrolling element 33 is a scroll wheel.

In other words, when the first button 31 is pressed down by the user, the corresponding first triggering switch is pressed and triggered by the first button 31 to generate a first button signal (e.g. a left button signal). Similarly, when the second button 32 is pressed down by the user, the corresponding second triggering switch 38 is pressed and triggered the second button 32 to generate a second button signal (e.g. a right button signal). Moreover, when the scrolling element 33 is rotated by the user, the scrolling element 33 generates a scrolling signal.

As shown in FIG. 5, the displacement detecting module 37 is disposed on the circuit board 34 and partially exposed to a bottom opening 301 of the main body 30. The displacement detecting module 37 is used for detecting movement of the main body 30 and generating a corresponding displacement signal. In this embodiment, the displacement detecting module 37 comprises a first light-emitting element 371, an optical assembly 372, and an optical sensing element 373. The first light-emitting element 371 is disposed on the circuit board 34 for emitting a first light beam B1. The optical assembly 372 is disposed within the main body 30. The optical assembly 372 is used for allowing the first light beam B1 to go through and projecting the first light beam B1 on the working surface T, which is disposed under the main body 30. In this embodiment, the optical assembly 372 comprises a reflective mirror 3721 and a focusing lens 3722. The reflective mirror 3721 is used for reflecting the first light beam B1, so that the first light beam B1 is projected on the working surface T. The reflective mirror 3721 comprises a first reflective surface 3721A and a second reflective surface 3721B. The first reflective surface 3721A is located near the first light-emitting element 371 for reflecting the first light beam B1 that is emitted by the first light-emitting element 371. The second reflective surface 3721B is located near the working surface T. After the first light beam B1 is reflected by the first reflective surface 3721A, the first light beam B1 is further reflected by the second reflective surface 3721B, so that the first light beam B1 is projected on the working surface T. After the first light beam B1 is reflected by the working surface T, the first light beam B1 is further focused by the focusing lens 3722. After the focused first light beam B1 is received by the optical sensing element 373, the optical sensing element 373 generates the displacement signal. In other words, the optical sensing element 373 is used for receiving the first light beam B1, and generating the displacement signal according to the first light beam B1. In this embodiment, the first light-emitting element 371 is a light emitting diode (LED), and the optical sensing element 373 is a charge-coupled device (CCD). Moreover, the change of the moving resolution denotes the change of the sensitivity of the optical sensing element 373.

A process of generating the displacement signal will be illustrated in more details as follows. When the mouse device 3 is placed on the working surface T but is not moved, the first light-emitting element 371 emits the first light beam B1 to the reflective mirror 3721. In the reflective mirror 3721, the first light beam B1 is firstly reflected by the first reflective surface 3721A and the first light beam B1 is further reflected by the second reflective surface 3721B, so that the first light beam B1 is projected on the working surface T. Then, the first light beam B1 is reflected by the working surface T and further focused by the focusing lens 3722. After the focused first light beam B1 is received by the optical sensing element 373, the optical sensing element 373 generates a first working surface image. When the mouse device 5 is placed on the working surface T and moved to a specified position, the first light beam B1 emitted by the first light-emitting element 371 is sequentially reflected by the reflective mirror 3721 and the working surface T and focused by the focusing lens 3722. After the focused first light beam B1 is received by the optical sensing element 373, the optical sensing element 373 generates a second working surface image. Next, the optical sensing element 373 compares the first working surface image with the second working surface image, thereby acquiring a displacement of the main body 30 relative to the working surface T and generating the displacement signal according to the displacement amount. That is, when the mouse device 3 is moved on the working surface T, the displacement detecting module 37 detects the displacement of the main body relative to the working surface T and generates the displacement signal according to the displacement amount. After the displacement signal is received by the computer host 41, the cursor 422 shown on the display screen 42 is moved by the computer host 41 according to the displacement signal.

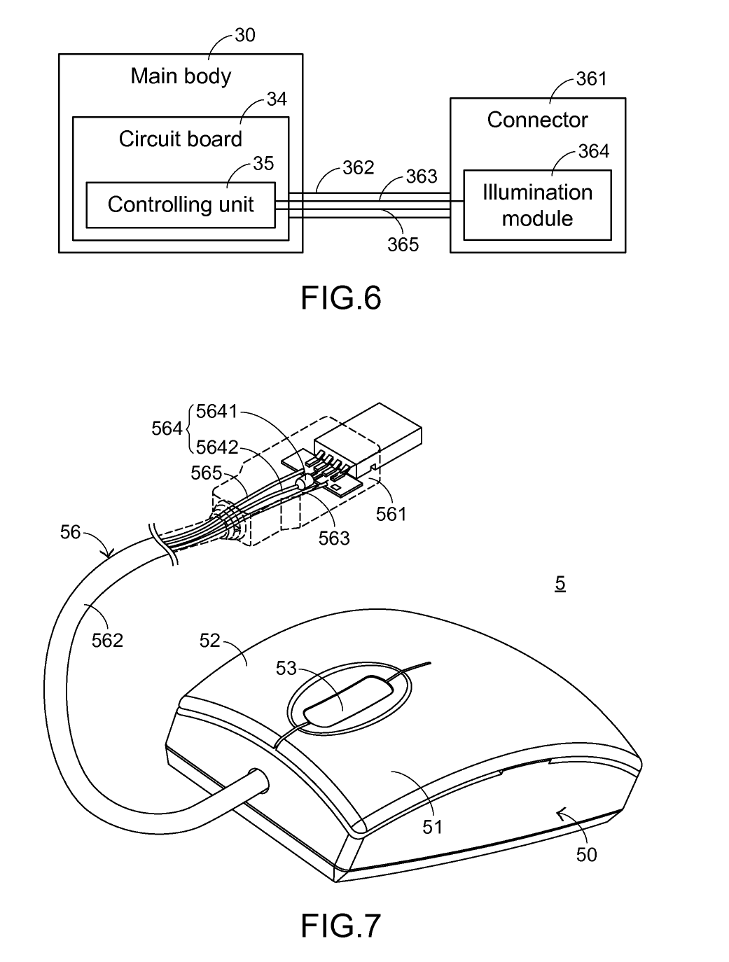

FIG. 6 is a schematic functional block diagram illustrating the mouse device according to the first embodiment of the present invention. Please refer to FIGS. 3, 4, 5 and 6. The controlling unit 35 is disposed within the main body 30 and installed on the circuit board 34. When a first switching signal is received, the controlling unit 35 issues a first illumination control signal. When a second switching signal is received, the controlling unit 35 issues a second illumination control signal. The sources of the first switching signal and the second switching signal will be illustrated as follows. The connecting cable 36 is connected with the controlling unit 35 and protruded outside the main body 30. Through the connecting cable 36, the computer host 41 is connected with the main body 30. In this embodiment, the connecting cable 36 comprises a connector 361, a wire part 362, an illumination control line 363, an illumination module 364, and an operation control line 365. The connector 361 is located at a first end of the wire part 362 in order to be plugged into the connecting port 411 of the computer host 41. The wire part 362 is connected with the connector 361. In addition, the wire part 362 is connected with the controlling unit 35 through the circuit board 34. The illumination control line 363 is disposed within the wire part 362 and connected with the controlling unit 35. The first illumination control signal or the second illumination control signal may be transmitted through the illumination control line 363. The operation control line 365 is disposed within the wire part 362 and connected with the controlling unit 35. Through the operation control line 365, plural mouse signals from the controlling unit 35 are transmitted to the computer host 41, or the electric power from the computer host 41 is transmitted to the controlling unit 35 to enable the controlling unit 35, the displacement detecting module 37, an encoder (not shown) of the scrolling element 33, the first triggering switch, the second triggering switch 38 or other electronic components on the circuit board 34. The above mouse signals contain the first button signal, the second button signal, the scrolling signal and the displacement signal. In this embodiment, the wire part 362 is made of a light-transmissible material. Consequently, a first state light beam or a second state light beam emitted by the inner portion of the wire part 362 is visible through the wire part 362.

As shown in FIG. 4, the illumination module 364 is disposed within the connector 361 and the wire part 362, and connected with the illumination control line 363. The illumination module 364 emits the first state light beam according to the first illumination control signal, or the illumination module 364 emits the second state light beam according to the second illumination control signal. In this embodiment, the illumination module 364 comprises a second light-emitting element 3641 and a light guide strip 3642. The second light-emitting element 3641 is disposed within the connector 361 and connected with the illumination control line 363. The second light-emitting element 3641 emits the first state light beam according to the first illumination control signal transmitted through the illumination control line 363, or the second light-emitting element 3641 emits the second state light beam according to the second illumination control signal transmitted through the illumination control line 363. The light guide strip 3642 is disposed within the wire part 362. Moreover, an end of the light guide strip 3642 is located near the second light-emitting element 3641. When the first state light beam is guided to the wire part 362, the first state light beam is visible through the wire part 362. When the second state light beam is guided to the wire part 362, the second state light beam is visible through the wire part 362. In this embodiment, the second light-emitting element 3641 is a light emitting diode, the light guide strip 3642 is a fiber-optic strip, the first state light beam is a first color light beam (e.g. a blue color light beam), and the second state light beam is a second color light beam (e.g. a red color light beam). The examples of these components and these light beams are not restricted. Alternatively, in some other embodiments, the first state light beam is emitted by providing a first power to the second light-emitting element 3641, and the second state light beam is emitted by providing a second power to the second light-emitting element 3641, wherein the magnitude of the first power is different from the magnitude of the second power.

Please refer to FIGS. 3 and 4 again. The mouse device 3 may be operated in two operation modes. For example, the two operation modes are associated with moving resolution. The moving resolution of the mouse device 3 is 800 dpi in the first operation mode, and the moving resolution of the mouse device 3 is 1600 dpi in the second operation mode. Moreover, the first operation mode may be set as a default operation mode of the mouse device 3. For providing an operation mode switching function to the mouse device 3, a mode switching driver should be previously installed in the computer host 41. Consequently, after the mode switching driver is activated and the operation mode switching function is enabled, a switching function window 423 is opened by the computer host 41. In addition, the switching function window 423 is shown on the display screen 42. Meanwhile, the user may operate the mouse device 3 to control the switching function window 423 in order to have computer host 41 generate the second switching signal. The second switching signal is transmitted to the controlling unit 35 of the mouse device 3 through the operation control line 365. After the second switching signal is received by the controlling unit 35, the default operation mode (e.g. the first operation mode) is switched to the second operation mode. In the second operation mode, the second illumination control signal is transmitted to the second light-emitting element 3641 through the illumination control line 363. According to the second illumination control signal, the second light-emitting element 3641 emits the second state light beam to be viewed by the user. According to the second state light beam viewed through the wire part 362, the user realizes that the operation mode of the mouse device 3 is switched to the second operation mode corresponding to the 1600-dpi moving resolution.

On the other hand, if the user wants to switch the operation mode of the mouse device 3 to the first operation mode corresponding to the 800-dpi moving resolution, the user may operate the mouse device 3 to control the switching function window 423 in order to have computer host 41 generate the first switching signal. The first switching signal is transmitted to the controlling unit 35 of the mouse device 3 through the operation control line 365. After the second switching signal is received by the controlling unit 35, the operation mode of the mouse device 3 is switched from the second operation mode to the first operation mode. In the first operation mode, the first illumination control signal is transmitted to the second light-emitting element 3641 through the illumination control line 363. According to the first illumination control signal, the light beam emitted by the second light-emitting element 3641 is changed. That is, the second light-emitting element 3641 emits the first state light beam. According to the first state light beam viewed through the wire part 362, the user realizes that the operation mode of the mouse device 3 is switched to the first operation mode corresponding to the 800-dpi moving resolution. As mentioned above, the first switching signal and the second switching signal, which are received by the controlling unit 35, are generated by the computer host 41 in response to the user's operations.

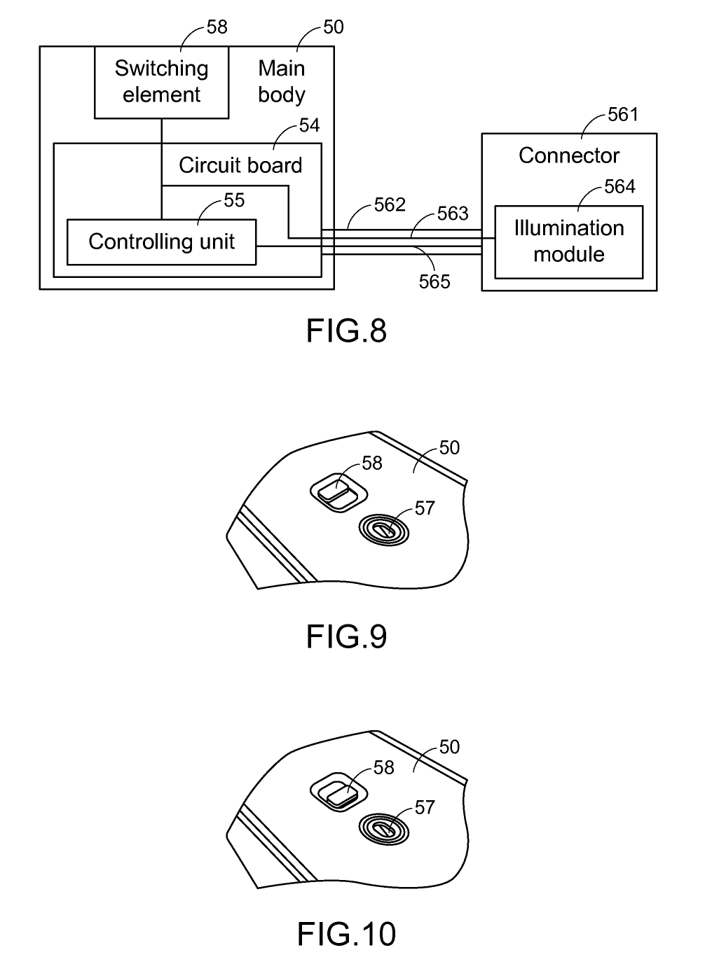

The present invention also provides a mouse device of a second embodiment. FIG. 7 is a schematic perspective view illustrating the structure of a mouse device with a prompting function according to a second embodiment of the present invention. FIG. 8 is a schematic functional block diagram illustrating the mouse device according to the second embodiment of the present invention. Please refer to FIGS. 7 and 8. The mouse device 5 comprises a main body 50, a first button 51, a second button 52, a scrolling element 53, a circuit board 54, a controlling unit 55, a connecting cable 56, a displacement detecting module 57, a switching element 58, a first triggering switch (not shown), and a second triggering switch (not shown). In this embodiment, the connecting cable 56 comprises a connector 561, a wire part 562, an illumination control line 563, an illumination module 564, and an operation control line 565. Moreover, the illumination module 564 comprises a second light-emitting element 5641 and a light guide strip 5642. The structures of the mouse device 5 are substantially identical to those of the mouse device 3 of the first embodiment, and are not redundantly described herein.

Except for the following three items, the mouse device 5 is substantially identical to the mouse device 3 of the first embodiment.

Firstly, the scrolling element 53 is a touchpad. In case that the user's finger is firstly placed on the scrolling element 53 and then slid on the scrolling element 53, the scrolling element 53 is triggered to generate a scrolling signal. Alternatively, in another embodiment, the scrolling element is an optical finger navigation (OFN) sensing module. Similarly, in case that the user's finger is firstly placed on the scrolling element 53 and then slid on the scrolling element 53, the scrolling element 53 is triggered to generate a scrolling signal. The structures and operating principles of the touchpad and the OFN sensing module are well known to those skilled in the art, and are not redundantly described herein.

Secondly, the first state light beam emitted by the second light-emitting element 5641 flicks at a first frequency, and the second state light beam emitted by the second light-emitting element 5641 flicks at a second frequency, wherein the first frequency is different from the second frequency.

Thirdly, the mouse device 5 of this embodiment further comprises the switching element 58. The switching element 58 is disposed on the main body 50 and exposed outside the main body 50. By adjusting the switching element 58 to a specified position, the switching element 58 is triggered to generate a first switching signal to the controlling unit 55 or generate a second switching signal to the controlling unit 55. According to the first switching signal or the second switching signal, the operation mode of the mouse device 5 is adjusted. For example, if the switching element 58 is adjusted to a first position (see FIG. 9), the switching element 58 issues the first switching signal to the controlling unit 55. According to the first switching signal, the mouse device 5 is operated in the first operation mode. On the other hand, if the switching element 58 is adjusted to a second position (see FIG. 10), the switching element 58 issues the second switching signal to the controlling unit 55. According to the second switching signal, the operation mode of the mouse device 5 is switched from the first operation mode to the second operation mode. In this embodiment, the switching element is the source that generates the first switching signal and the second switching signal. Consequently, it is not necessary to install the mode switching driver in the computer system 5. After the position of the switching element 58 on the main body 50 is adjusted by the user directly, the operation mode of the mouse device 5 can be easily adjusted.

The following two aspects should be specially described. Firstly, due to the arrangement of the switching element 58, the connection relationship between the controlling unit 55 and the connecting cable 56 is distinguished. The connection relationship will be illustrated as follows. As shown in FIG. 8, the controlling unit 55 is connected with the switching element 58, and the connecting cable 56 is connected with the controlling unit 55 and the switching element 58. The illumination control line 563 is disposed within the wire part 562 and connected between the switching element 58 and the controlling unit 55. For example, the illumination control line 563 is connected with a metal conductor line between the switching element 58 and the controlling unit 55, wherein the metal conductor line is disposed on the circuit board 54. Consequently, during the process of transmitting the first switching signal or the second switching signal to the controlling unit 55, the first switching signal or the second switching signal is retrieved by the illumination control line 563. In addition, the first switching signal or the second switching signal is further transmitted to the illumination module 564 through the illumination control line 563. That is, according to the first switching signal or the second switching signal, which is transmitted from the switching element 58 and through the illumination control line 563, the second light-emitting element 5641 emits the first state light beam or the second state light beam. In contrast, as described in the first embodiment, the second light-emitting element emits the first state light beam or the second state light beam according to the first illumination control signal or the second illumination control signal from the controlling unit. The is, after the first switching signal or the second switching signal is received by the controlling unit 55, the first illumination control signal or the second illumination control signal is not additionally transmitted to the illumination module 564. Secondly, the mode switching function of the mouse device of the present invention is not restricted to the function of switching the moving resolution. That is, the mode switching function of the mouse device of the present invention can be applied to any other appropriate mode switching function.

It is noted that numerous modifications and alterations may be made while retaining the teachings of the invention. In some embodiments, the connector of the connecting cable comprises a grip part and an electrical connection part. By gripping the grip part, the connector may be held by the user's fingers. The electrical connection part is disposed on the grip part. The electrical connection part may be electrically connected with the connecting port of the computer host. Since the illumination module is disposed within the connector, the grip part may be equipped with a lampshade, and an additional light guide structure is arranged between the second light-emitting element and the lampshade. Consequently, the first state light beam or the second state light beam from the second light-emitting element is guided to the lampshade through the light guide structure. The first state light beam or the second state light beam is transmitted through the lampshade to form an indicating lamp. Alternatively, in some embodiment, the lampshade may be designed to have a special shape. For example, the lampshade may have a specified logo mark. When the first state light beam or the second state light beam is emitted by the second light-emitting element, the lampshade with the specified logo mark has a special illuminating efficacy.

From the above descriptions, the present invention provides a mouse device with a prompting function. An illumination control line is additionally disposed within a wire part of a connecting cable of the mouse device. Consequently, the illumination control line is connected with an illumination module and a controlling unit, or connected between the controlling unit and a switching element. Different illumination control signals (or switching signals) may be transmitted through the illumination control line. Consequently, different state light beams may be generated by the illumination module. Moreover, since the wire part of the connecting cable is made of a light-transmissible material, a first state light beam or a second state light beam may be viewed by the user through the wire part. According to the first state light beam or the second state light beam, the user may realize the operation mode of the mouse device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A mouse device with a prompting function, the mouse device comprising:
a main body;
a controlling unit disposed within the main body, wherein the controlling unit issues a first illumination control signal according to a first switching signal, or the controlling unit issues a second illumination control signal according to a second switching signal; and
a connecting cable connected with the controlling unit, wherein the connecting cable is connectable with a computer system, and the connecting cable comprises:
a connector plugged into the computer system;
a wire part connected with the connector and the controlling unit;
an illumination control line disposed within the wire part and connected with the controlling unit, wherein the first illumination control signal or the second illumination control signal is transmitted through the illumination control line; and
an illumination module disposed within the connector and the wire part, and connected with the illumination control line, wherein the illumination module emits a first state light beam according to the first illumination control signal, or the illumination module emits a second state light beam according to the second illumination control signal, wherein the wire part is made of a light-transmissible material, so that the first state light beam or the second state light beam is visible through the wire part.

2. The mouse device according to claim 1, wherein illumination module comprises:
a light-emitting element disposed within the connector and connected with the illumination control line, wherein the light-emitting element emits the first state light beam according to the first illumination control signal, or the light-emitting element emits the second state light beam according to the second illumination control signal; and
a light guide strip disposed within the wire part, wherein an end of the light guide strip is located near the light-emitting element, wherein when the first state light beam is guided to the wire part through the light guide strip, the first state light beam is visible though the wire part, wherein when the second state light beam is guided to the wire part through the light guide strip, the second state light beam is visible though the wire part.

3. The mouse device according to claim 2, wherein when the first illumination control signal is generated by the controlling unit according to the first switching signal and the first illumination control signal is transmitted to the light-emitting element through the illumination control line, the light-emitting element emits the first state light beam according to the first illumination control signal, wherein when the second illumination control signal is generated by the controlling unit according to the second switching signal and the second illumination control signal is transmitted to the light-emitting element through the illumination control line, the light-emitting element emits the second state light beam according to the second illumination control signal.

4. The mouse device according to claim 1, further comprising a switching element, wherein the switching element is disposed on the main body and exposed outside the main body, wherein when the switching element is triggered, the first switching signal is generated to the controlling unit or the second switching signal is generated to the controlling unit, wherein an operation mode of the mouse device is adjusted by the controlling unit according to the first switching signal or the second switching signal.

5. The mouse device according to claim 1, wherein the connecting cable further comprises an operation control line, wherein the operation control line is disposed within the wire part and connected with the controlling unit, wherein plural mouse signals are transmitted from the controlling unit to the computer system through the operation control line, or an electric power is transmitted from the computer system to the controlling unit through the operation control line so as to enable the controlling unit.

6. The mouse device according to claim 5, wherein the first switching signal or the second switching signal which is received by the controlling unit is generated by the computer system, wherein the first illumination control signal or the second illumination control signal which is generated by the controlling unit according to the first switching signal or the second switching signal is transmitted to the illumination module through the illumination control line.

7. A mouse device with a prompting function, the mouse device comprising:
a main body;
a switching element disposed on the main body and exposed outside the main body, wherein by adjusting the switching element, a first switching signal or a second switching signal is selectively generated;
a controlling unit disposed within the main body and connected with the switching element, wherein an operation mode of the mouse device is adjusted by the controlling unit according to the first switching signal or the second switching signal; and
a connecting cable connected with the controlling unit and the switching element, wherein the connecting cable is connectable with a computer system, and the connecting cable comprises:
a connector plugged into the computer system;
a wire part connected with the connector and the controlling unit;
an illumination control line disposed within the wire part and connected between the switching element and the controlling unit, wherein the first switching signal or the second switching signal is transmitted through the illumination control line; and
an illumination module disposed within the connector and the wire part, and connected with the illumination control line, wherein the illumination module emits a first state light beam according to the first switching signal, or the illumination module emits a second state light beam according to the second switching signal, wherein the wire part is made of a light-transmissible material, so that the first state light beam or the second state light beam is visible through the wire part.

8. The mouse device according to claim 7, wherein illumination module comprises:
a light-emitting element disposed within the connector and connected with the illumination control line, wherein the light-emitting element emits the first state light beam according to the first switching signal, or the light-emitting element emits the second state light beam according to the second switching signal; and
a light guide strip disposed within the wire part, wherein an end of the light guide strip is located near the light-emitting element, wherein when the first state light beam is guided to the wire part through the light guide strip, the first state light beam is visible though the wire part, wherein when the second state light beam is guided to the wire part through the light guide strip, the second state light beam is visible though the wire part.

9. The mouse device according to claim 8, wherein when the first switching signal from the switching element is received by the controlling unit and the operation mode of the mouse device is a first operation mode, the first switching signal is transmitted to the light-emitting element through the illumination control line, and the light-emitting element emits the first state light beam according to the first switching signal, wherein when the second switching signal from the switching element is received by the controlling unit and the operation mode of the mouse device is switched from the first operation mode to a second operation mode, the second switching signal is transmitted to the light-emitting element through the illumination control line, and the light-emitting element emits the second state light beam according to the second switching signal.

10. The mouse device according to claim 7, wherein the connecting cable further comprises an operation control line, wherein the operation control line is disposed within the wire part and connected with the controlling unit, wherein plural mouse signals are transmitted from the controlling unit to the computer system through the operation control line, or an electric power is transmitted from the computer system to the controlling unit through the operation control line so as to enable the controlling unit.
